(19) United States
(12) Patent Application Publication
(10) Pub. No.: US 2010/0162350 A1
(43) Pub. Date: Jun. 24, 2010

(54) SECURITY SYSTEM OF MANAGING IRC AND HTTP BOTNETS, AND METHOD THEREFOR

(75) Inventors: Hyun Cheol JEONG, Seoul (KR); Chae Tae IM, Seoul (KR); Seung Goo JI, Seoul (KR); Sang Kyun NOH, Gwangju (KR); Joo Hyung OH, Seoul (KR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Korea Information Security Agency, Seoul (KR)

(21) Appl. No.: 12/544,569

(22) Filed: Aug. 20, 2009

(30) Foreign Application Priority Data
Dec. 24, 2008 (KR) 10-2008-0133644

(51) Int. Cl. H04L 29/06; G06F 17/00

(52) U.S. Cl. 726/1

(57) ABSTRACT

The present invention relates to a security system of managing IRC and HTTP botnets and a method therefor. More specifically, the present invention relates to a system and a method that detects a botnet in an Internet service provider network to store information related to the detected botnet in a database and performs security management of IRC and HTTP botnets, including a botnet management security management (BMSM) system, configured to visualize the information related to the detected botnet and establish an against policy related to the detected botnet. Accordingly, the present invention provides a security system of managing IRC and HTTP botnets that can efficiently performs the security management of IRC and HTTP botnets by using the BMSM system

### CROSS-REFERENCE TO RELATED APPLICATION

This application claims priority to Korean Patent Application No. 2008-0133644, filed on Dec. 24, 2008, the entire contents of which are hereby incorporated by reference.

### FIELD OF THE INVENTION

The present invention relates to a security system of managing IRC and HTTP botnets and a method therefor.

### BACKGROUND OF THE INVENTION

Bot is an abbreviation of “robot.” A bot refers to a personal computer (PC) having malicious software. A lot of bots, i.e., personal computers having malicious software are connected by networks, and thus botnets are formed. Such botnets have been used for various malicious behaviors such as DDoS attack, illegal collection of private information, phishing, malicious codes distribution, spam mail, and the like. The botnets can be classified according to protocols that are used by the botnet. In case that the protocol between a command & control (C&C) server and bots of a botnet is an IRC protocol, the botnet can be classified as an IRC botnet. If the protocol is an HTTP protocol, the botnet can be classified as an HTTP botnet.

As such, the attacks of botnets are continuously increasing and the attack methods are gradually diversified. Moreover, the recent attacks of botnets have been used for financial crimes. In addition to causing Internet service errors by DDoS, there appear bots causing personal system errors and illegally obtaining private information. Cyber rimes are growing through illegal drains of user information such as ID and password and financial information. Moreover, the existing attacks of hackers have been performed to be proud of their skills or for skill competitions through communities, while the recent hacker groups are using the botnets for financial purposes.

To make matters worse, the botnets becomes more complicated by using high techniques such as periodic update, execution compressing technology, self-conversion of code, encryption of command channel, and/or the like so that it is difficult to detect and avoid the botnets. The sources of the botnets publically spread, and the botnets are modified into thousands of types. Undesirably, it is possible to easily create or control bot-codes through user interfaces so that persons who have no professional knowledge or technology can make and use the botnets, causing significant problems.

### SUMMARY OF THE INVENTION

In view of the above, the present invention provides a security system of managing IRC and HTTP botnets, and a method therefor, which can efficiently performs a security management of IRC and HTTP botnets.

In accordance with an aspect of the present invention, there is provided a system that detects a botnet in an Internet service provider network to store information related to the detected botnet in a database and performs security management of IRC and HTTP botnets, including a botnet management security management (BMSM) system, configured to visualize the information related to the detected botnet and establish an against policy related to the detected botnet.

The system further includes a plurality of traffic information collecting sensors, placed in a plurality of Internet network provider networks to transfer traffic information to the BMBS system; and a managing system, configured to manage the traffic information collecting sensors and setting and state information of a botnet detection system.

The BMSM system include: a security event collector module, configured to receive a security event from the botnet detection system and deal with the received security event; an anomaly organization log analysis log, configured to analyze a similarity with the botnet of the security event; an unclassified behavior log analysis module, configured to receive and classify unclassified behavior logs in the security event; a botnet against technology module, configured to establish the against policy related to the detected botnet; a detection log management module, configured to manage the information related to the detected botnet, botnet malicious behavior information, policy information and botnet against policy information; a policy management module, configured to set a policy of the BMSM system; a system management module, configured to register the botnet detection system, the traffic information collecting sensor, a domain name system sink hole server, a BGP router, a domain name system server, and a web firewall to the BMSM system; a statistic reporting management module, configured to create statistics data based on the information related to the detected botnet and the malicious behavior information; and a botnet monitoring module, configured to monitor a malicious behavior and an organization of the detected botnet.

The security event collector module includes a security event collection classification module, configured to classify the collected security events; an against policy checking module, configured to transmit an against policy request message for blocking botnets according to the policy established by the policy management module; a collection/classification/policy generation management module for the security event; and an abnormal organization log buffer, configured to store an abnormal organization log in the collected security event.

The system anomaly organization log analysis log include: an abnormal organization log search/classification module, configured to periodically read an abnormal organization log buffer in the security event and write an organization log, which is generated in a same time slot, in a matrix per organization; a botnet C&C comparison module, configured to compare botnet C&C information in a present time slot with botnet C&C information in a previous time slot; a C&C analyzing and detecting module, configured to analyze a similarity with source IPs of botnet C&C of the present and previous time slot; a C&C extracting module, configured to receive a botnet traffic detected from the C&C analyzing and detecting module and extracts C&C per protocol to store the analysis result in a log; and an against policy setting module generates a requiring message for setting a black list generation against policy related to a newly detected botnet C&C in the BMSM system.

The botnet against technology module sets a botnet against policy including black list sharing, domain name system sink hole, HTTP botnet C&C URL access blocking, and BGP feeding.

The system detection log management module include: a connection pool module, configured to manage a connection with the database; an enquiry/inserting/deleting/correcting module, configured to deal with requests of enquiry, inserting, deleting, and correcting for the database; a query classifying module, configured to classify request messages to the detection log management module and transfer the classified request messages to the enquiry/inserting/deleting/correcting module; a duplicate checking module, configured to check whether there is any duplicate of an inserting request to the database and a correcting request in the enquiry/inserting/deleting/correcting module; a SQLP generating/transmitting module, configured to receive request messages and generate corresponding SQL to transfer the SQL; and a result transmitting module, configured to returns the acknowledged result after the generated SQL is transferred.

The system management module receives and deals with state information transmitted from the plurality of traffic information collecting sensors that collect botnet information in the Internet service provider network or the botnet detection systems that detect the botnets based on the traffic collected by the traffic information collecting sensors and deals with a state information enquiry request from a management consol graphic user interface through which a user is able to manipulate the BMSM system displayed on a web.

In accordance with an aspect of the present invention, there is provided a method that detects a botnet in an Internet service provider network to store information related to the detected botnet in a database and performs security management of IRC and HTTP botnets, including: detecting a botnet in the Internet service provider network; and establishing an against policy of the botnet.

The method detecting of the botnet in the Internet service provider network includes: collecting traffic in the Internet service provider network; classifying logs based on the collected traffic; and dealing with the logs.

The method logs include detection logs, classification behavior logs, abnormal organization logs, and non-classification behavior logs.

The method dealing with the logs includes: dealing with the detection logs; dealing with the classification behavior logs; dealing with the abnormal organization logs; and dealing with non-classification behavior logs.

The method further includes creating statistics data for the information related to the detected botnet.

### BRIEF DESCRIPTION OF THE DRAWINGS

The objects and features of the present invention will become apparent from the following description of embodiments, given in conjunction with the accompanying drawings, in which:

FIG. 1 shows a structure of a security system of managing IRC and HTTP botnets in accordance with an embodiment of the present invention;

FIG. 2 shows a structure of a botnet detection system of an information sharing system of IRC and HTTP botnets in accordance with an embodiment of the present invention;

FIG. 3 shows a stack of a security system of managing IRC and HTTP botnets in accordance with an embodiment of the present invention;

FIG. 4 is a conceptual view showing a botnet management security management system of a security system of managing IRC and HTTP botnets in accordance with an embodiment of the present invention;

FIG. 5 shows a structure of a botnet management security management system of a security system of managing IRC and HTTP botnets in accordance with an embodiment of the present invention;

FIG. 6 shows a structure of a security event collector module of a security system of managing IRC and HTTP botnets in accordance with an embodiment of the present invention;

FIG. 7 is a flowchart for describing a security event collector module of a security system of managing IRC and HTTP botnets in accordance with an embodiment of the present invention;

FIG. 8 is a SEC sequence diagram showing how to deal with a detection/classification behavior log in a security system of managing IRC and HTTP botnets in accordance with an embodiment of the present invention;

FIG. 9 is a SEC sequence diagram showing how to deal with an abnormal organization behavior log in a security system of managing IRC and HTTP botnets in accordance with an embodiment of the present invention;

FIG. 10 shows a structure of an AOA module of a security system of managing IRC and HTTP botnets in accordance with an embodiment of the present invention;

FIG. 11 is a flowchart for describing an AOA module of a security system of managing IRC and HTTP botnets in accordance with an embodiment of the present invention;

FIG. 12 shows a structure of a BAT module of a security system of managing IRC and HTTP botnets in accordance with an embodiment of the present invention;

FIG. 13 is a flowchart for describing a BAT module of a security system of managing IRC and HTTP botnets in accordance with an embodiment of the present invention;

FIG. 14 is a BAT sequence diagram of a security system of managing IRC and HTTP botnets in accordance with an embodiment of the present invention;

FIG. 15 is a flowchart showing how to verify a botnet against policy setting request in a security system of managing IRC and HTTP botnets in accordance with an embodiment of the present invention;

FIG. 16 is a block diagram showing how to verify a botnet against policy setting request in a security system of managing IRC and HTTP botnets in accordance with an embodiment of the present invention;

FIG. 17 is a botnet statistics sequence diagram of a security system of managing IRC and HTTP botnets in accordance with an embodiment of the present invention;

FIG. 18 is a botnet zombie statistics sequence diagram of a security system of managing IRC and HTTP botnets in accordance with an embodiment of the present invention;

FIG. 19 is a domain name system sink hole traffic statistics sequence diagram of a security system of managing IRC and HTTP botnets in accordance with an embodiment of the present invention;

FIG. 20 is a report reservation sequence diagram of a security system of managing IRC and HTTP botnets in accordance with an embodiment of the present invention;

FIG. 21 is an integrated report sequence diagram of a security system of managing IRC and HTTP botnets in accordance with an embodiment of the present invention;

FIG. 22 is a sequence diagram of an initial screen and botnet C&C click of a security system of managing IRC and HTTP botnets in accordance with an embodiment of the present invention;

FIG. 23 shows a structure of a BM module of a security system of managing IRC and HTTP botnets in accordance with an embodiment of the present invention;

FIG. 24 is a sequence diagram of refresh and zoom in/zoom out and timer of a security system of managing IRC and HTTP botnets in accordance with an embodiment of the present invention;

FIG. 25 is a TOP N statistics sequence diagram of a security system of managing IRC and HTTP botnets in accordance with an embodiment of the present invention;

FIG. 26 shows a structure of a DLM module of a security system of managing IRC and HTTP botnets in accordance with an embodiment of the present invention;

FIG. 27 shows a structure of a SM module of a security system of managing IRC and HTTP botnets in accordance with an embodiment of the present invention; and

FIG. 28 is a flowchart for describing a security method of managing IRC and HTTP botnets in accordance with an embodiment of the present invention.

### DETAILED DESCRIPTION OF THE EMBODIMENT

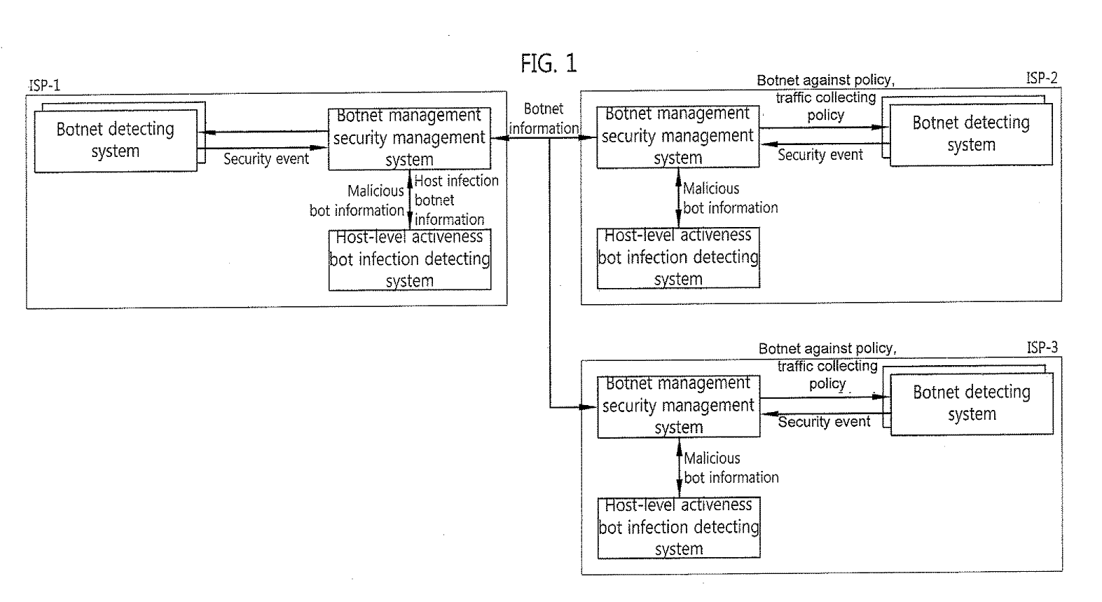

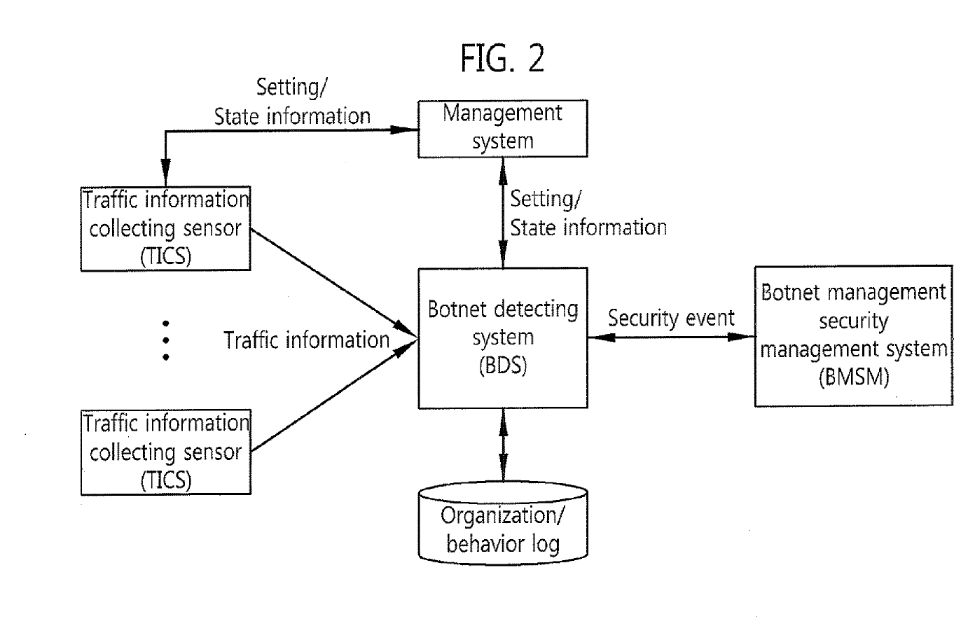

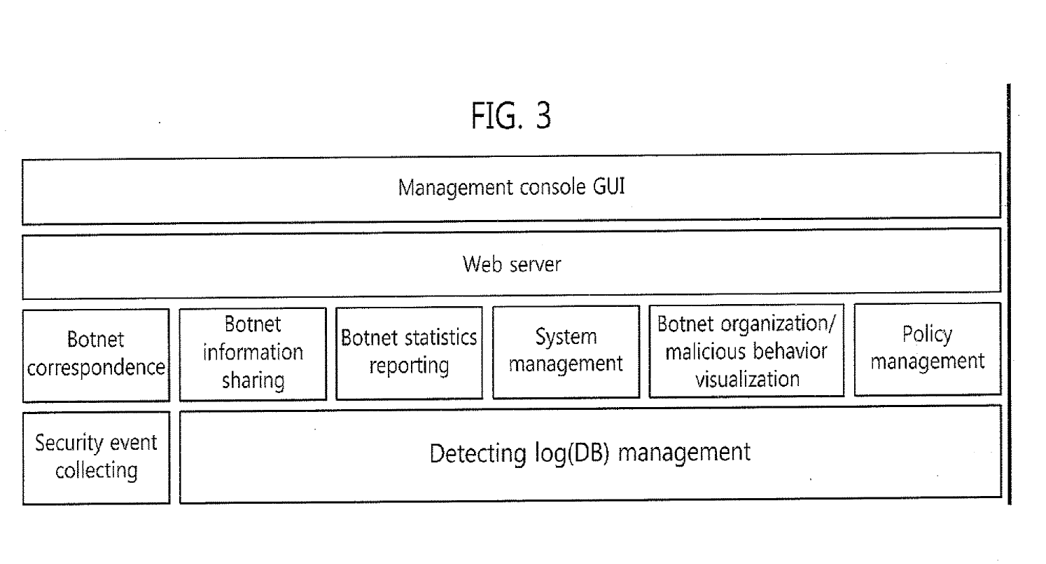

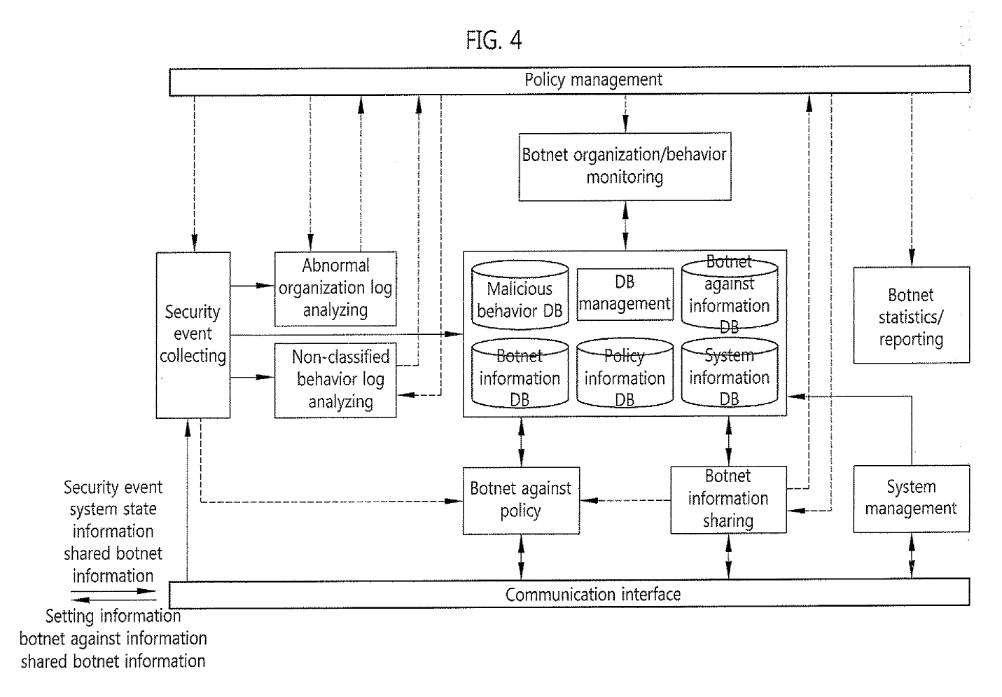

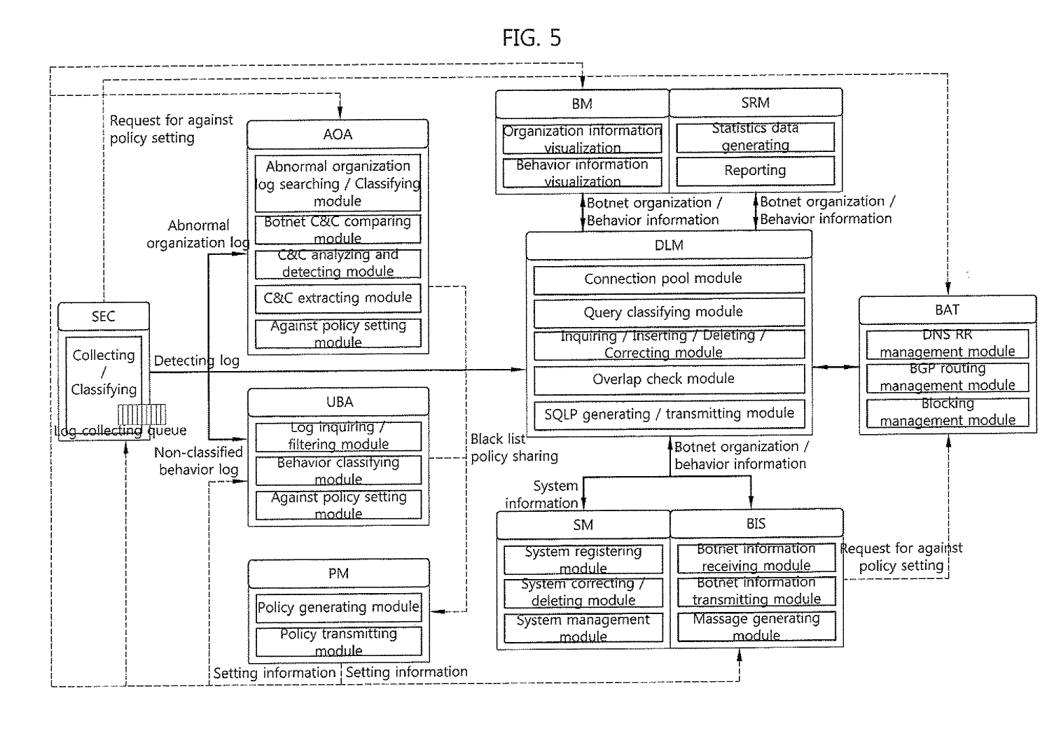

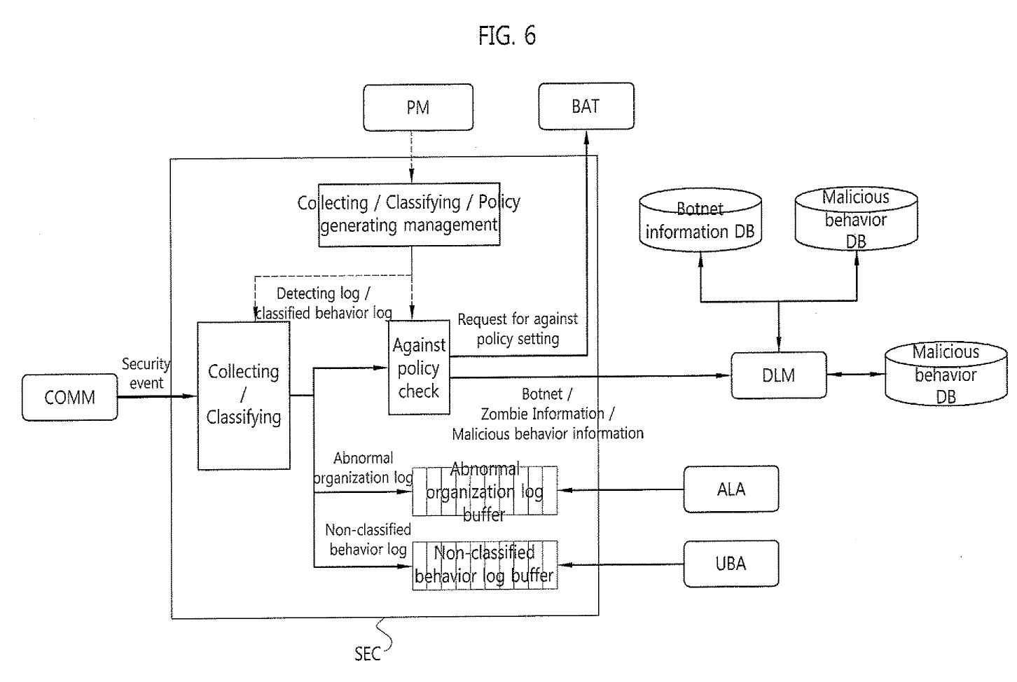

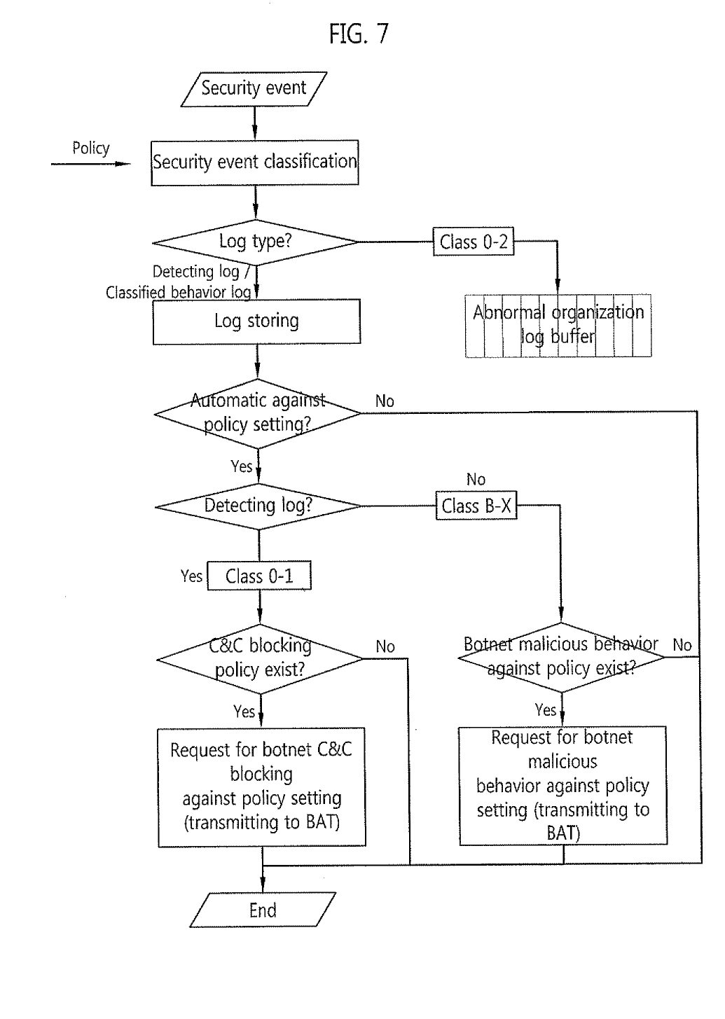

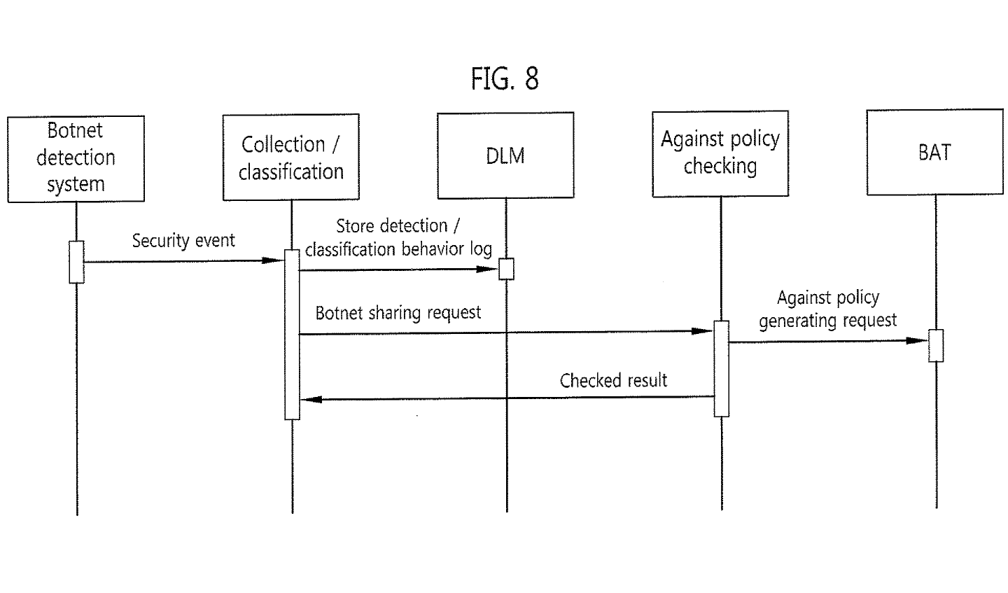

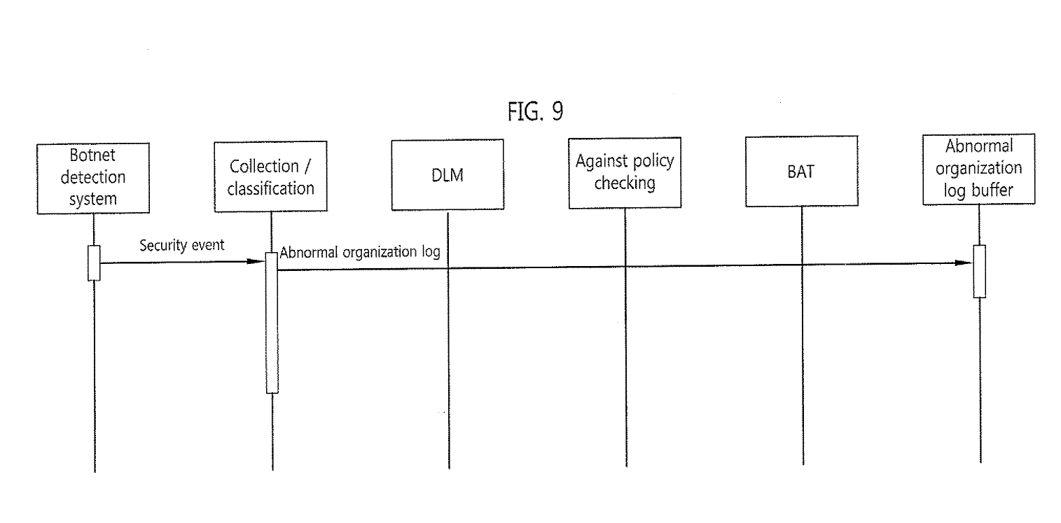

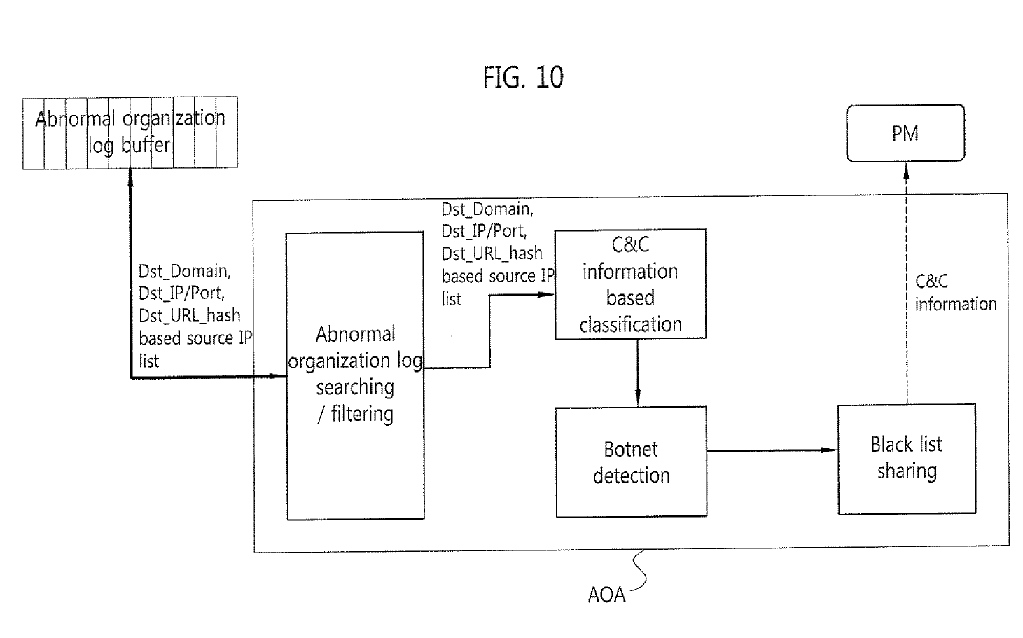

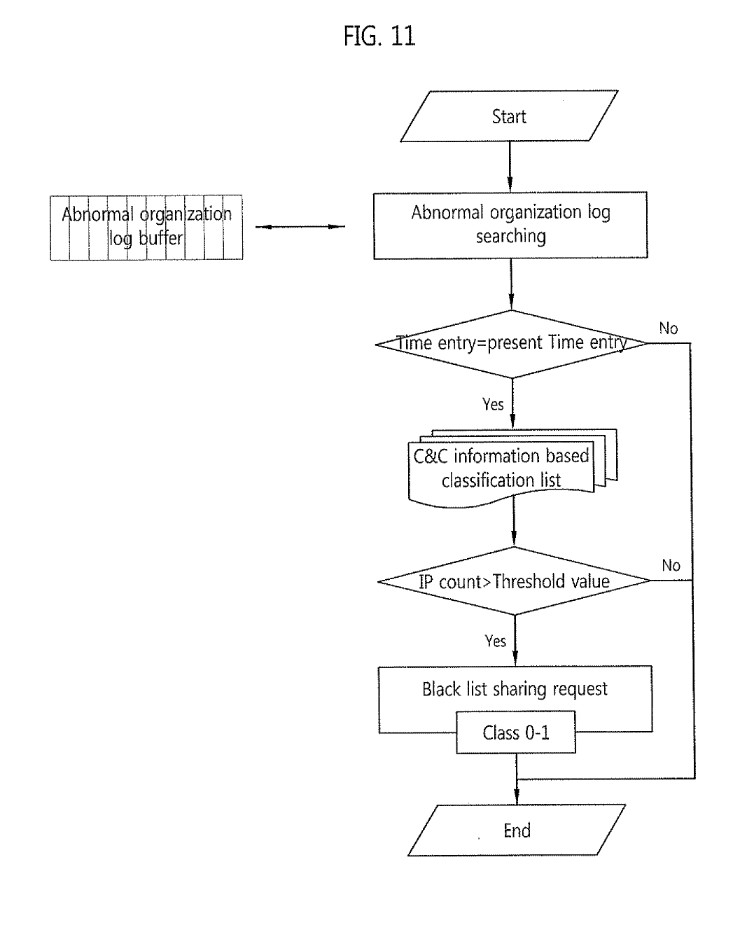

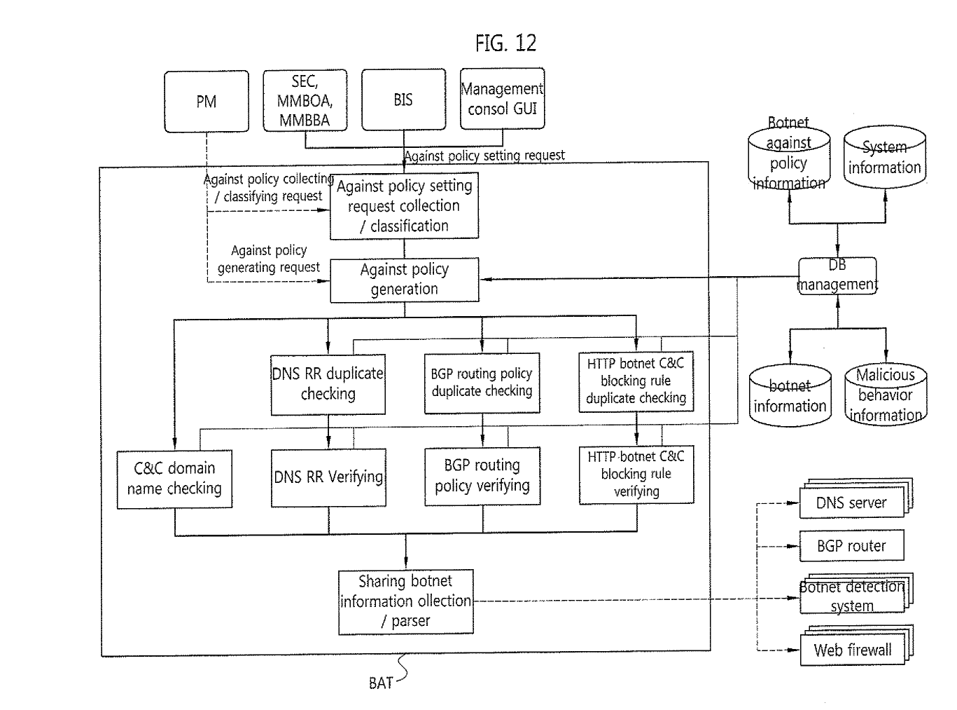

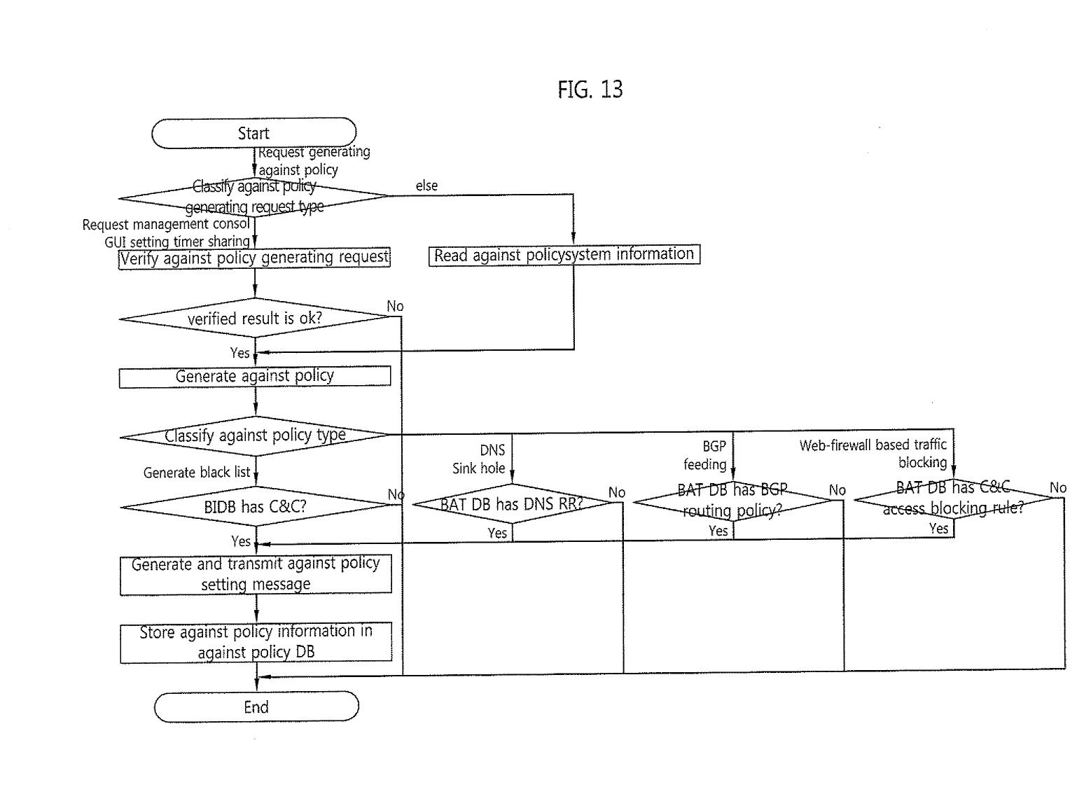

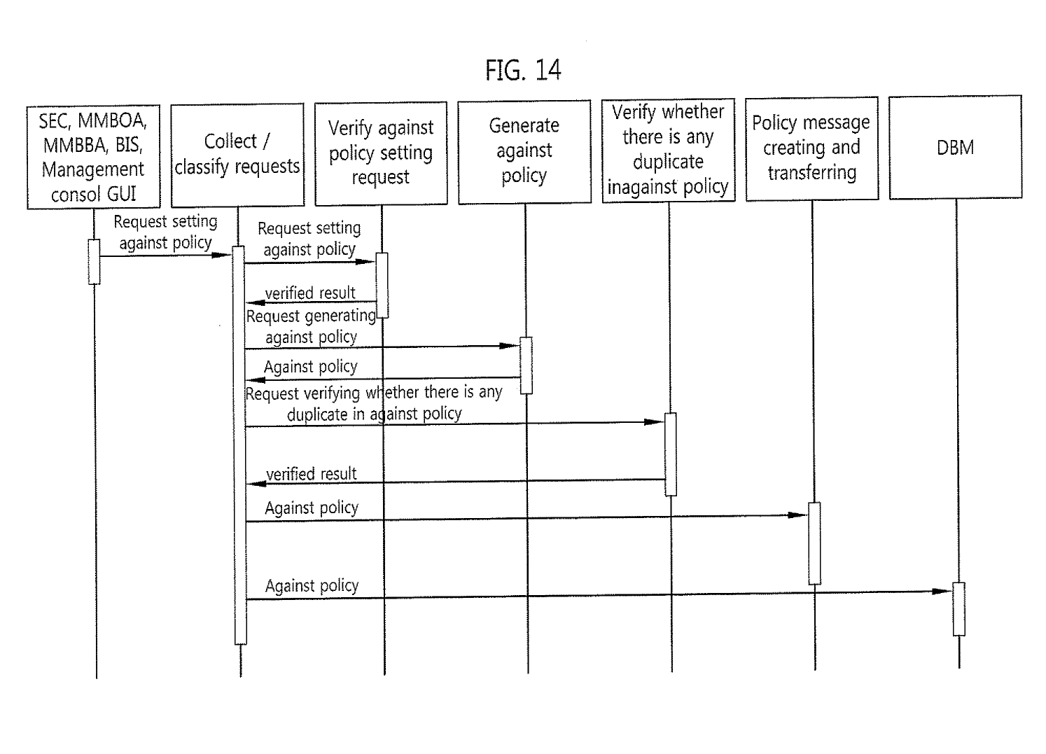

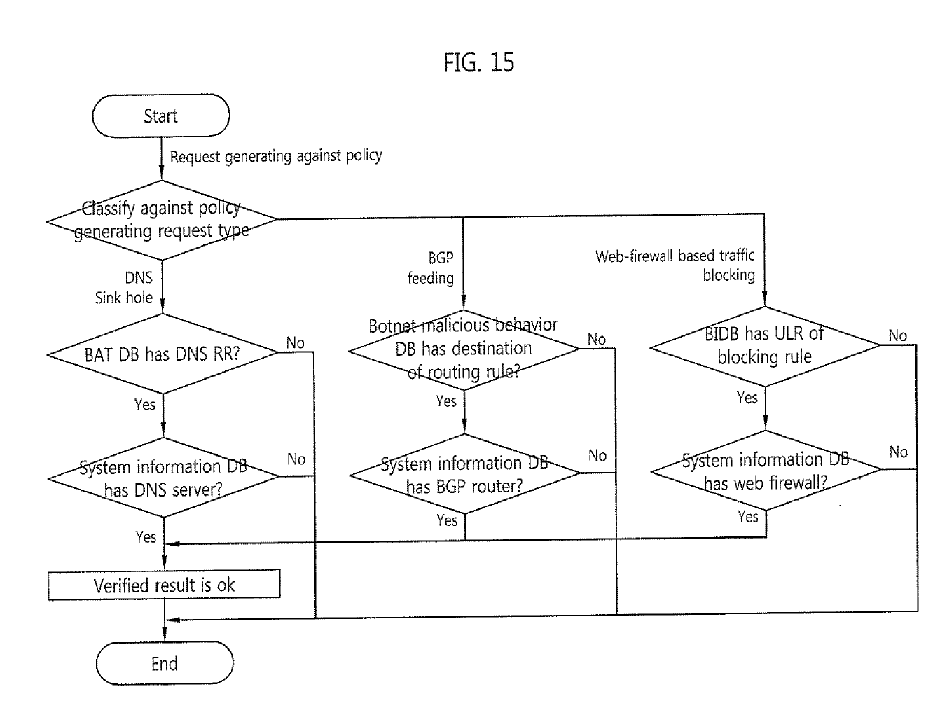

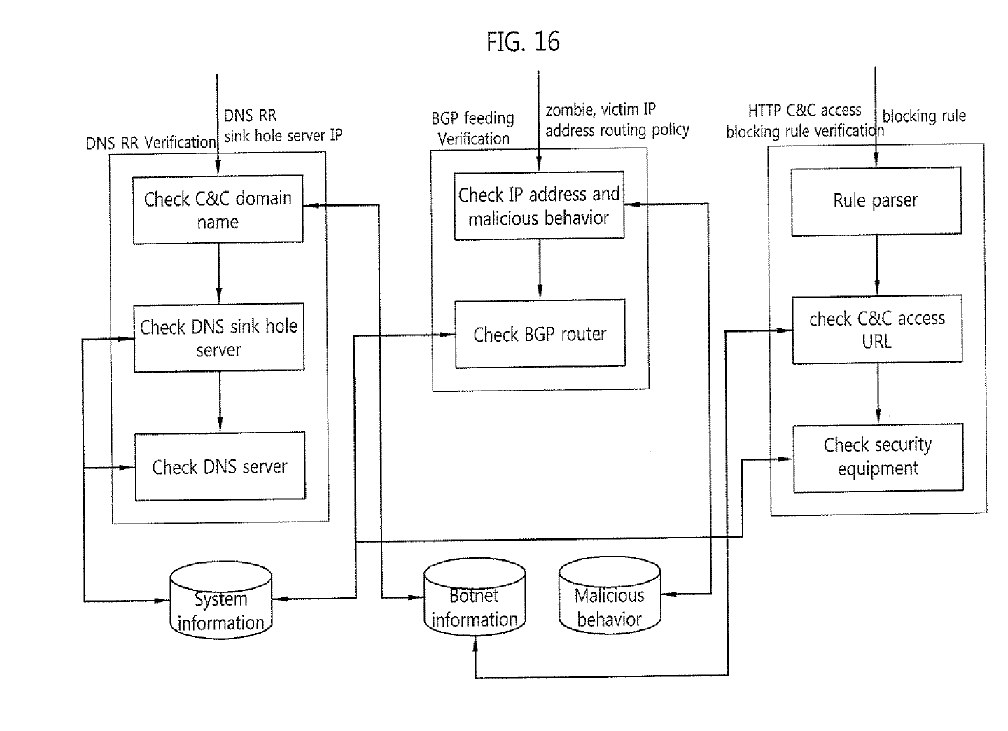

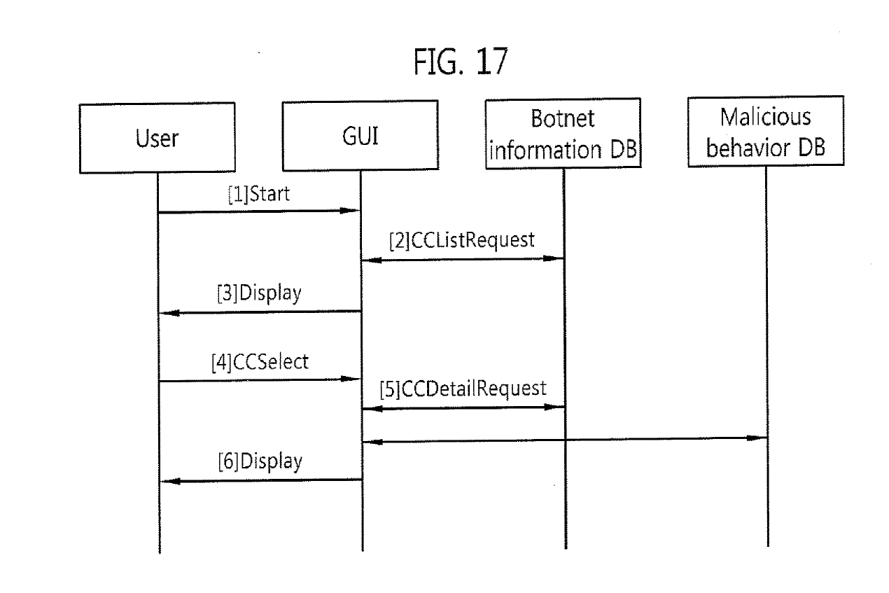

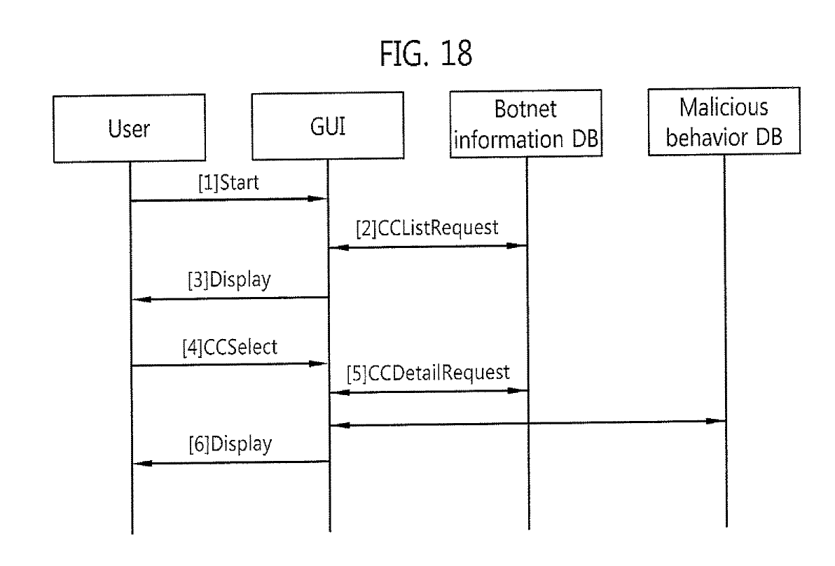

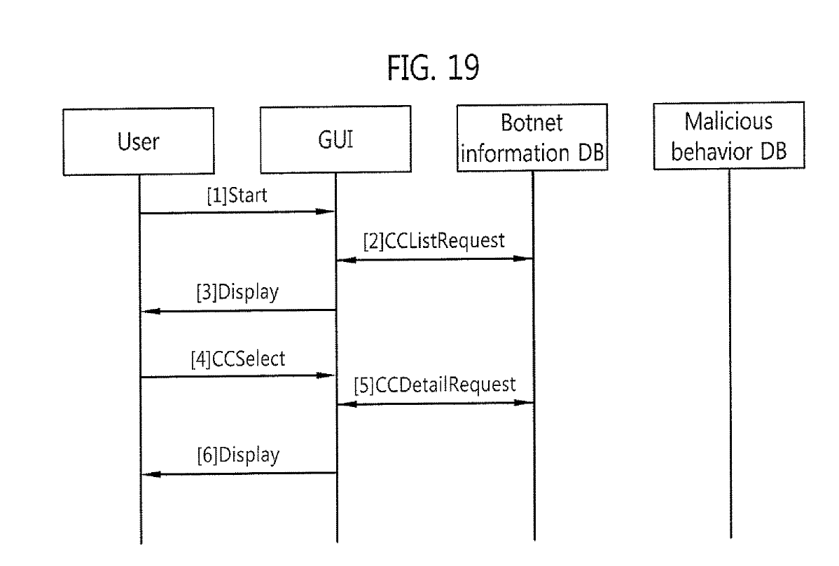

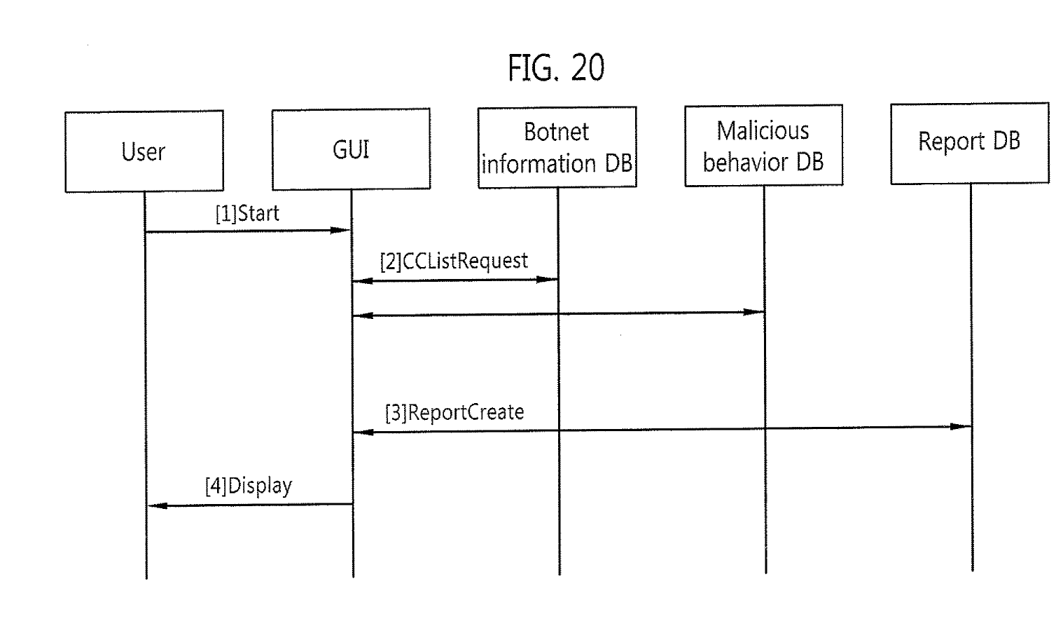

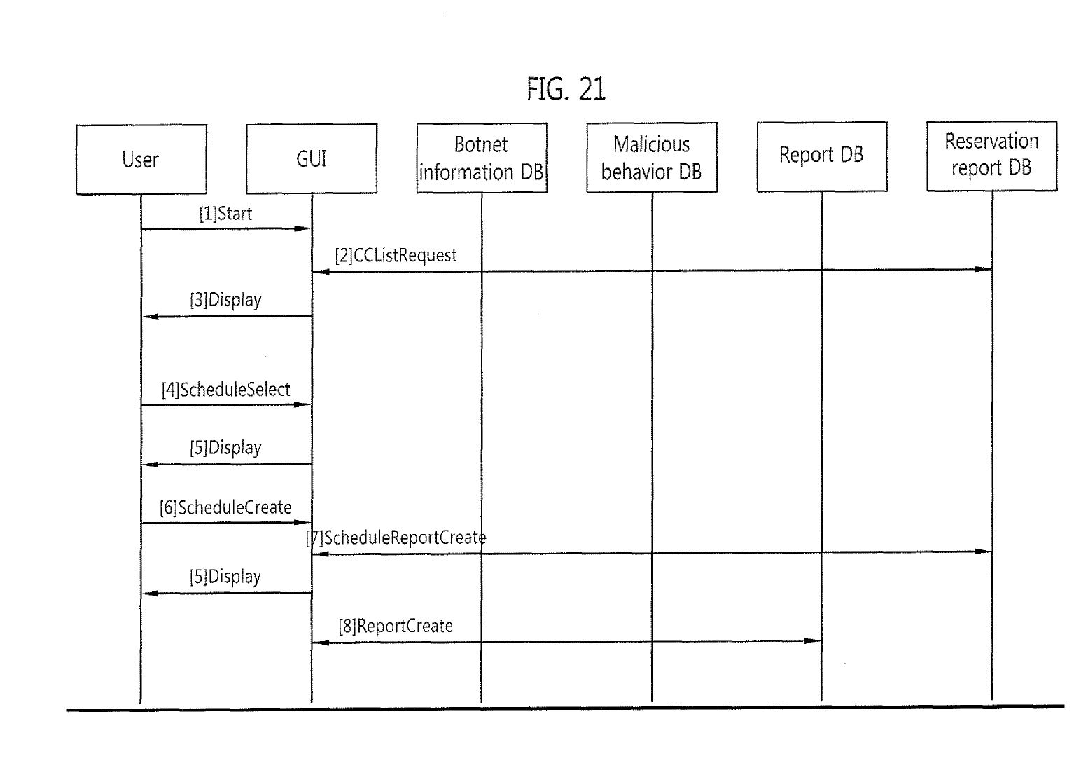

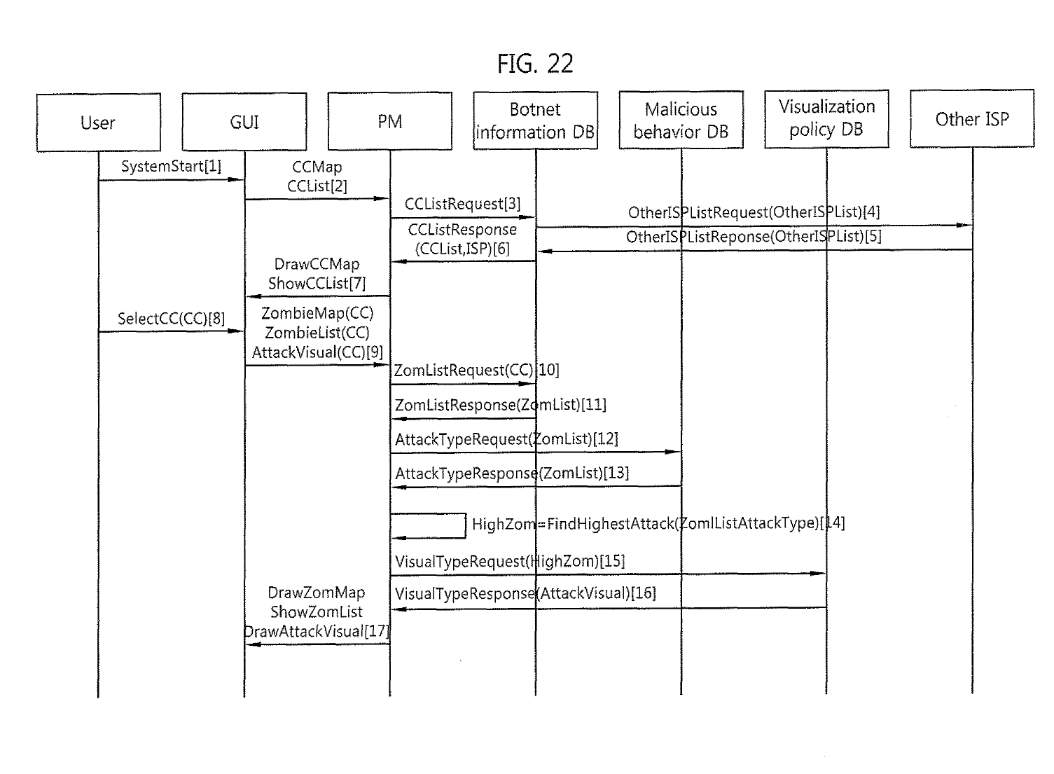

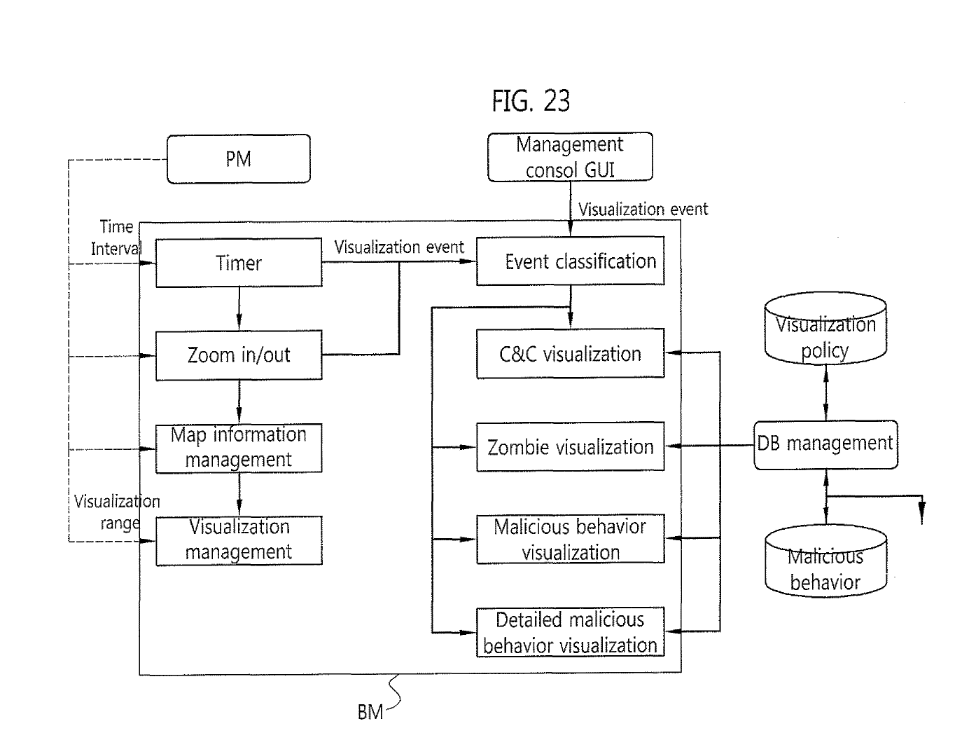

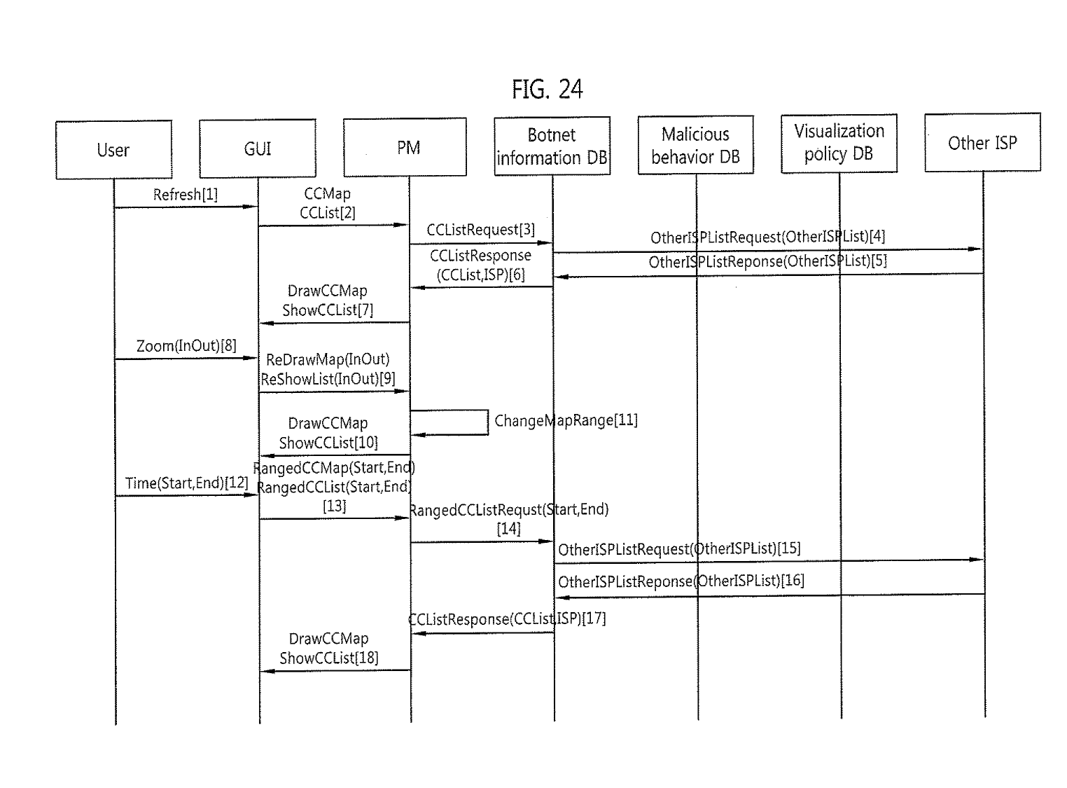

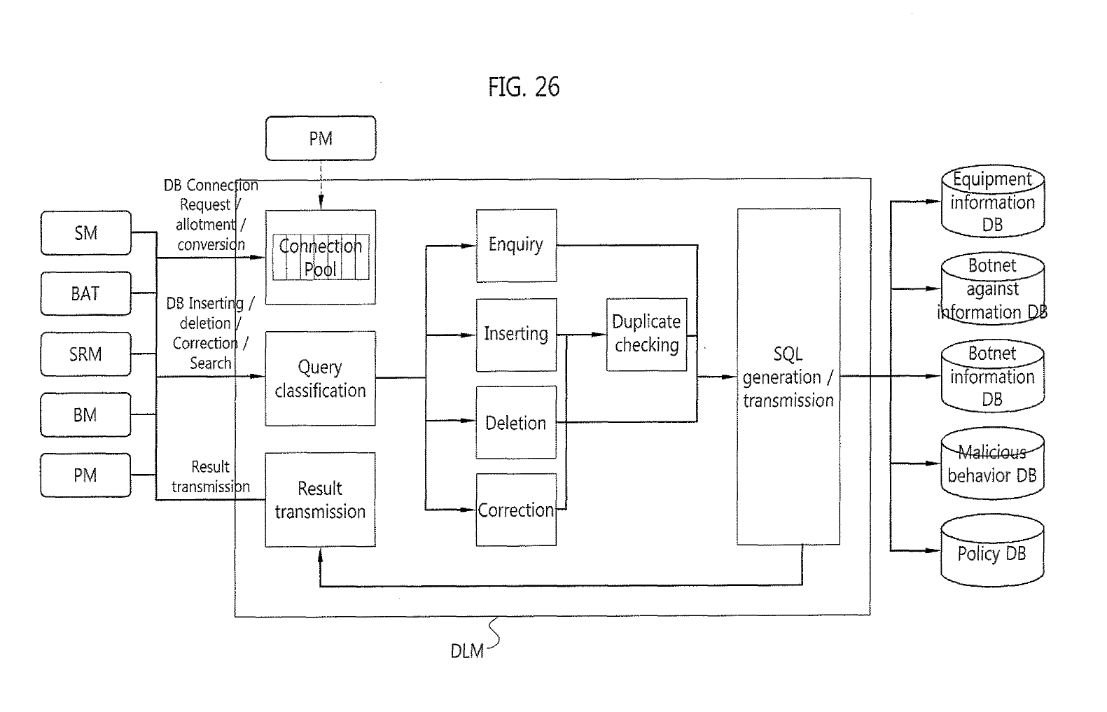

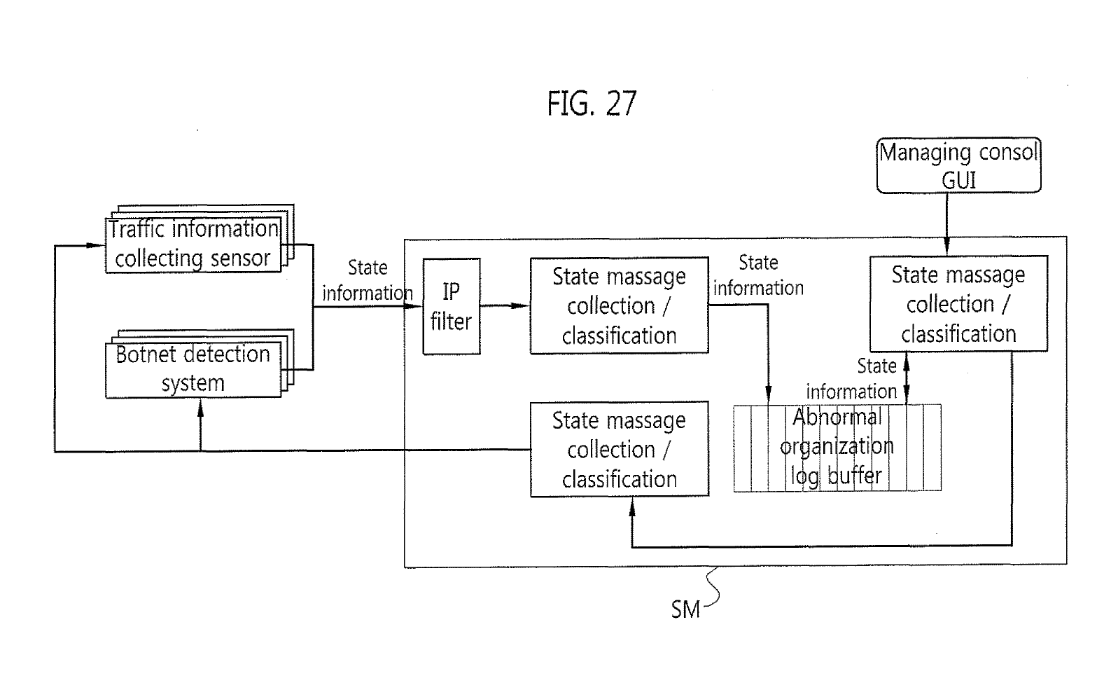

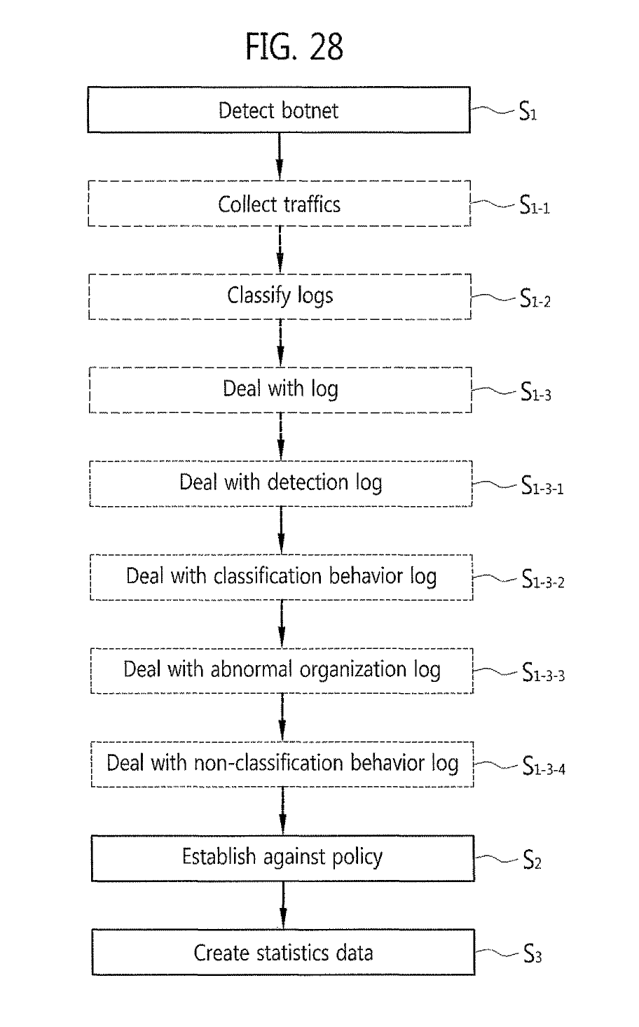

FIG. 1 shows a structure of a security system of managing IRC and HTTP botnets in accordance with an embodiment of the present invention. FIG. 2 shows a structure of a botnet detection system of an information sharing system of IRC and HTTP botnets in accordance with an embodiment of the present invention. FIG. 3 shows a stack of a security system of managing IRC and HTTP botnets in accordance with an embodiment of the present invention. FIG. 4 is a conceptual view showing a botnet management security management system of a security system of managing IRC and HTTP botnets in accordance with an embodiment of the present invention. FIG. 5 shows a structure of a botnet management security management system of a security system of managing IRC and HTTP botnets in accordance with an embodiment of the present invention. FIG. 6 shows a structure of a security event collector module of a security system of managing IRC and HTTP botnets in accordance with an embodiment of the present invention. FIG. 7 is a flowchart for describing a security event collector module of a security system of managing IRC and HTTP botnets in accordance with an embodiment of the present invention. FIG. 8 is a SEC sequence diagram showing how to deal with a detection/classification behavior log in a security system of managing IRC and HTTP botnets in accordance with an embodiment of the present invention. FIG. 9 is a SEC sequence diagram showing how to deal with an abnormal organization behavior log in a security system of managing IRC and HTTP botnets in accordance with an embodiment of the present invention. FIG. 10 shows a structure of an AOA module of a security system of managing IRC and HTTP botnets in accordance with an embodiment of the present invention. FIG. 11 is a flowchart for describing an AOA module of a security system of managing IRC and HTTP botnets in accordance with an embodiment of the present invention. FIG. 12 shows a structure of a BAT module of a security system of managing IRC and HTTP botnets in accordance with an embodiment of the present invention. FIG. 13 is a flowchart for describing a BAT module of a security system of managing IRC and HTTP botnets in accordance with an embodiment of the present invention. FIG. 14 is a BAT sequence diagram of a security system of managing IRC and HTTP botnets in accordance with an embodiment of the present invention. FIG. 15 is a flowchart showing how to verify a botnet against policy setting request in a security system of managing IRC and HTTP botnets in accordance with an embodiment of the present invention. FIG. 16 is a block diagram showing how to verify a botnet against policy setting request in a security system of managing IRC and HTTP botnets in accordance with an embodiment of the present invention. FIG. 17 is a botnet statistics sequence diagram of a security system of managing IRC and HTTP botnets in accordance with an embodiment of the present invention. FIG. 18 is a botnet zombie statistics sequence diagram of a security system of managing IRC and HTTP botnets in accordance with an embodiment of the present invention. FIG. 19 is a domain name system sink hole traffic statistics sequence diagram of a security system of managing IRC and HTTP botnets in accordance with an embodiment of the present invention. FIG. 20 is a report reservation sequence diagram of a security system of managing IRC and HTTP botnets in accordance with an embodiment of the present invention. FIG. 21 is an integrated report sequence diagram of a security system of managing IRC and HTTP botnets in accordance with an embodiment of the present invention. FIG. 22 is a sequence diagram of an initial screen and botnet C&C click of a security system of managing IRC and HTTP botnets in accordance with an embodiment of the present invention. FIG. 23 shows a structure of a BM module of a security system of managing IRC and HTTP botnets in accordance with an embodiment of the present invention. FIG. 24 is a sequence diagram of refresh and zoom in/zoom out and timer of a security system of managing IRC and HTTP botnets in accordance with an embodiment of the present invention. FIG. 24 is a TOP N statistics sequence diagram of a security system of managing IRC and HTTP botnets in accordance with an embodiment of the present invention. FIG. 26 shows a structure of a DLM module of a security system of managing IRC and HTTP botnets in accordance with an embodiment of the present invention. FIG. 27 shows a structure of a SM module of a security system of managing IRC and HTTP botnets in accordance with an embodiment of the present invention. Finally, FIG. 28 is a flowchart for describing a security method of managing IRC and HTTP botnets in accordance with an embodiment of the present invention.

A security system of managing IRC and HTTP botnets in accordance with an embodiment of the present invention, as shown in FIG. 1, includes a botnet detecting system, a botnet management security management system that collects information from the botnet detecting system, and a host-level activeness bot infection detecting system, each of which are provided in an internet service provider (ISP) network. Here, the ISP network refers to a service network including lines, etc. through which each person or group can access the Internet. In the present embodiment, there are three ISP networks, i.e., first to third ISP networks (ISP-1, ISP-2, ISP-3). The present invention is not limited to the embodiment and is applicable to a network system having at least one ISP networks.

The botnet detecting system is provided in the ISP network to detect a botnet, which behaviors on a pertinent ISP network, on a basis of traffic information collected by a traffic information collecting sensor. Each ISP according to an embodiment of the present invention, as shown in FIG. 2, includes: a traffic information collecting sensor (TICS); a botnet detecting system (BDS), detecting a botnet by using traffic information collected by the traffic information collecting sensor; a management system, managing the settings and state information of the traffic information collecting sensor and the botnet detecting system; and a botnet management security management (BMSM) system.

The traffic information collecting sensor collects the traffic information of a pertinent ISP network to detect a botnet. At this time, the traffic information collecting sensors are provided as many as the number m of the botnet detecting system×(multiplication sign) the number n of the traffic information collecting sensors provided in the pertinent botnet detecting system. Moreover, the traffic collection sensor collects domain name system (DNS) traffic and traffic information according to a collection policy determined in a botnet management security management (BMSM) system. At this time, the collected traffic information is periodically transferred to the botnet detecting system.

The botnet detecting system detects a botnet on a basis of the traffic information collected by the traffic information collecting sensor. There may be m botnet detecting systems in a pertinent ISP network. The botnet detecting units detects the botnet by using the collected traffic information and analyze malicious behaviors. Such detected botnet information is transferred to the BMSM system. The management system may set the policy of the botnet detecting system and the traffic information collecting sensor.

A host-level activeness bot infection detecting system, which is independently installed, analyzes an actively infected malicious bot and provides bot information that a botnet uses.

The BMSM system provides a function that can visualize botnet information of a pertinent ISP network and set against policy. At this time, one BMSM system is typically located in an ISP network. In the BMSM system, as shown in FIG. 3, a user can operate an interface for botnet correspondence, botnet information statistic reporting, system management, botnet organization/malicious behavior visualization, and policy management through a web browser by using HTTP. As shown in FIG. 4, the BMSM system analyzes an abnormal organization log and a non-classification behavior log of a security event from the botnet detecting systems. The BMSM system monitors and stores a botnet organization/behavior using the analyzed abnormal organization log and non-classification behavior log. Thereafter, the BMSM system establishes a botnet against policy using the stored botnet organization/behavior, and shares a botnet information with another ISP through a communication interface. In addition, the BMSM system can take statistics on the botnet information and reports it. More details with regard to the BMSM system according to an embodiment of the present invention will be described referring to the enclosed drawings.

As shown in FIG. 5, the BMSM system includes a security event collector (SEC) module, an anomaly organization log analysis (AOA) module, an unclassified behavior log analysis (UBA) module, a botnet against technology (BAT) module, a statics reporting management (SRM) module, a botnet monitoring (BM) module, a detection log management (DLM) module, a policy management (PM) module, and a system management (SM) module. The BMSM system can also include a botnet information share (BIS) module.

As shown in FIG. 6, the security event collector (SEC) module receives from a plurality of botnet detecting systems security event having detection log, classification behavior log, and abnormal organization log. Here, the detection log refers to botnet information detected as the result of analyzing botnet organization in the botnet detecting system, and the classification behavior log refers to botnet behavior information detected as the result of analyzing botnet behavior in the botnet detecting system. The abnormal organization log refers to a log that performs the transferring to the BMSM system when the similarity value is equal to or greater than a minimum threshold value and is equal to or smaller than a reliable threshold value as the result of analyzing botnet organization in the botnet detecting system. The logs may be classified according to class information of a security event message header. The SEC module includes a collection/classification/policy generation management module, a security event collection classification module, an against policy check module, and a buffer. At this time, the buffer includes an abnormal organization log buffer and a non-classification behavior log.

The security event collection classification module classifies collected security events to transfer the detection log and the classification behavior log to the against policy check module and stores abnormal organization log in the abnormal organization log buffer.

The against policy check module stores the detection log and the classification behavior log in a botnet information database or a botnet behavior. In case that automatic correspondence is required according to a policy determined by the PM module, an against policy requiring message for blocking botnet C&C access or botnet malicious behavior is transferred to the BAT module. At this time, the PM module determines whether the automatic correspondence is performed for the detection log.

As shown in FIG. 7, message processing of the SEC module may be distinguished into processing of the detection log/classification behavior log and storing the abnormal organization log in a buffer, and a corresponding policy may be determined according to ‘generation of automatic against policy related to detection information’ determined by the PM module.

As shown in FIG. 8, for the processing of the detection log, the detection log classified from the security event is stored in a botnet information database (BIDB) or a botnet behavior database (BBDB). At this time, when the function of “automatic against policy setting” of the detection information is turned on after the database is stored, it is checked whether there is the against policy of botnet access C&C blocking. If there is no against policy of the botnet access C&C blocking, a requiring message for setting the against policy of the botnet access C&C blocking is generated and transferred to the BAT module. At this time, a botnet C&C access blocking policy has a C&C URL access blocking using domain name system sink hole and web firewall.

For the processing of the classification behavior log, the classification behavior log classified from the security event is stored in the BBDB. Moreover, when the function of ‘automatic against policy setting’ of the classification behavior log is turned on after the database is stored, it is checked whether there is the against policy of botnet malicious behavior. If there is no against policy of botnet malicious behavior, a requiring message for setting the against policy of the botnet malicious behavior is generated and transferred to the BAT module.

As shown in FIG. 9, for the processing of the abnormal organization log, the abnormal organization log classified from the security event is stored in an abnormal organization log buffer. For the processing of the non-classification behavior log, the non-classification behavior log classified from the security event is stored in a non-classification behavior log buffer.

As shown in FIG. 10, for an anomaly organization log analysis (AOA) module, transfers an abnormal log to the BMSM system, as the result of analyzing a domain similarity, an IP/Port similarity, and uniform resource locator (URL) similarity, when the similarities are equal or greater than a minimum threshold value and smaller than a reliable threshold value. At this time, the BMSM system collects and analyzes the abnormal logs from a plurality of botnet detecting systems. The AOA module includes an abnormal organization log search/classification module, a botnet C&C comparison module, a C&C analyzing and detecting module, a C&C extracting module, and an against policy setting module.

The abnormal organization log search/classification module periodically reads an abnormal organization log buffer and classifies a organization log generated in a same time slot into Dst domain, Dst/IP/Port, or Dst hash to write corresponding source IPs in matrixes.

The botnet C&C comparison module compares botnet C&C information in the present time slot with botnet C&C information in the previous time slot. At this time, it is preferable to delete botnet C&C information having no precious time slot.

The C&C analyzing and detecting module analyzes the similarities of the source IPs of botnet C&C information having no previous time slot. At this time, such similarity analysis includes analyses of the domain similarity, the IP/Port similarity, and the URL similarity.

The domain similarity analysis is performed by analyzing a matrix a specific time after queries are classified per domain and corresponding source IPs is written in matrixes. As such, after the similarities are analyzed, a zombie IP list is generated. At this time, the zombie refers to an infected computer.

For the IP/Port similarity analysis, DST_IP/Port information is read and the source IPs transmitting packets matching to each IP/Port combination is written in the matrixes. After a specific time has passed, the similarity is measured by the matrix. The zombie IP list is generated.

For URL similarity analysis, DST_URL information is read and queries are classified per each URL and corresponding source IPs is written in matrixes. After a specific time has passed, the similarity is measured by the matrix. The zombie IP list is generated.

The C&C extracting module receives a botnet traffic detected from the C&C analyzing and detecting module and extracts C&C per protocol to store the analysis result in a log. At this time, the traffic having undergone the analysis is returned to a zombie list extracting module.

The against policy setting module generates a requiring message for setting “black list generation against policy” to information related to newly detected botnet C&C in the BMSM system to the botnet detecting system.

As shown in FIG. 11, the processing of the abnormal organization log in the AOA module is performed by periodically searching the abnormal organization log buffer. At this time, if the searched abnormal organization log does not correspond to a present time entry, it is preferable to delete the pertinent organization log in the buffer. In this case, the organization log corresponding to the present time entry is classified on a basis of C&C information. At this time, if an IP count value is greater than a threshold value after the classification, this is detected as a botnet. Information related to the detected botnet is transmitted to the PM module by generating a message of “black list sharing requirement.”

The unclassified behavior log analysis (UBA) module receives and classifies an unclassified behavior log and sets an against policy. For this, the botnet detecting system transmits the unclassified behavior log to BMSM system. The BMSM system receives the unclassified behavior logs from a plurality of botnet detecting systems to perform the classification.

As shown in FIG. 12, the botnet against technology (BAT) module establishes an against policy related to the detected botnet. Moreover, the BAT establishes an against policy such as application of domain name system sink hole, border gateway protocol (BGP) feeding, HTTP botnet C&C access URL blocking using web firewall, sharing of black lists, which are written based on the detected botnet. Such against policy may be generated by receiving “botnet against policy setting requirement” from SEC, MMBOA, MMBBA, BIS, and management consol graphic user interface. As such, after generating the against policies, the BAT module transmits the against policies to registered systems such as a domain name system server, a BGP router, a botnet detecting system, a web firewall, and the like. At this time, the botnet against policy that can be determined by using the BAT module includes black list sharing, domain name system sink hole, HTTP botnet C&C URL access blocking, and BGP feeding.

The black list sharing, which is the botnet against policy generated from the SEC, MMBOA, MMBBA, and BIS, shares information related to C&C with other AS botnet detecting systems if it is checked that a plurality of zombies access a new C&C in an AS (i.e. an area managed by the botnet detecting system) at a short time.

The domain name system sink hole, which is the botnet against policy generated from the SEC, MMBOA, and BIS, is used for mainly IRC-based botnet C&C access blocking. At this time, a domain name system resource record (DNS RR) for blocking the access of a newly found IRC botnet is generated and transferred to a domain name system server.

The HTTP botnet C&C URL access blocking, which is the botnet against policy generated from the SEC, MMBOA, and BIS, is used for mainly HTTP-based botnet C&C access blocking. The HTTP botnet C&C URL access blocking of zombies may be embodied through rule setting of public web firewall.

The BGP feeding, which is the botnet against policy generated from the SEC, MMBBA, and BIS, is used for blocking an attach behavior using a botnet such as DDoS or like. The DDoS, traffic, or the like that goes to a victim may be blocked through null routing, according to the against policy by BGP feeding.

As shown in FIG. 13 and FIG. 14, the message processing by the BAT module may include processing of botnet against policy setting requirement from a management consol graphic user interface and processing of remaining requirement. At this time, the processing of botnet against policy setting requirement from a management consol graphic user interface is performed by executing the verification of the against policy setting requirement, generating the against policy, and transmitting it to the registered system.

As shown in FIG. 15, the processing of a verifying message of the botnet against policy setting requirement may be distinguished into verifications of a DNS RR, BGP routing rule and public web-firewall based HTTP C&C URL access blocking rule. For this, the botnet against technology (BAT) module can include a DNS RR management module, a routing management module, and a blocking management module.

The verification of the domain name sink hole against policy sink hole with the DNS RR is performed by checking whether the BLDB has a domain name system included in the DNS RR and whether the BLDB also has a domain name system server to apply the DNS RR.

The verification of the BGP feeding policy with the BGP routing policy is performed by checking whether the BBDB has a destination address of the BGP routing policy and whether the BBDB has also the public web-firewall applied with the blocking rule.

As shown in FIG. 16, for the verification of the botnet against policy, a manager may manually perform an against policy verification process in the case of the against policy generating requirement from the managing consol graphic user interface. At this time, it is necessary to check system information or botnet information included in the against policy is information that is actually registered in the system information database.

The verification of the domain name system sink hole policy is performed by checking whether the botnet information database has a C&C domain name included in the DSN RR and whether there is a domain name system server to apply this. The verification of the BGP feeding policy is performed by checking whether there is a malicious behavior that attacks an IP address as a victim and also checking whether there is a BGP router to apply this. The verification of the HTTP C&C access blocking rule is performed by checking whether there is a HTTP botnet having as the C&C a pertinent URL after parsing and whether there is a security device to apply this. Of course, the black list sharing is not directly generated by a manager. Accordingly, the verifying process is unnecessary.

The statics reporting management (SRM) module generates botnet information and malicious behavior information as statistic data such as various graphs and tables. The SPM module also provides a reporting function for the generated statistic data. Such a statics reporting management unit can be used through a web-based user interface. For this, the statics reporting management (SRM) module can include a statistic data generating module, and a reporting module.

As shown in FIG. 17, for a botnet statistics sequence, a user starts [1] botnet statistics in a menu. The sequence performs the query to the botnet information database by setting a basic search condition as “one recent week” to collect [2] the results. The sequence represents the collected statistics (botnet time, botnet C&C domain name, IP address, holding zombie number, etc.) as transition graphs and assigns them in a descending order to display [3] them on a screen. The user requests [4] the pertinent statistics by using the search condition (statistics area, botnet time, C&C domain name, domain IP, port number, malicious behavior, etc.) of statistics items. The sequence queries the search conditions selected by the user as the botnet information database and malicious behavior database to collect [5] information and display [6] the results on the screen.

As shown in FIG. 18, for a botnet zombie statistics sequence, a user starts [1] botnet zombie statistics in a menu. Then, the sequence performs the query to the botnet information database by setting a basic search condition as “one recent week” to collect [2] the results. The sequence represents the collected statistics (botnet time, botnet C&C domain name, IP address, used bot binary, malicious behaviors, etc.) as transition graphs and assigns them in a descending order to display [3] them on a screen. The user requests [4] the pertinent statistics by using the search condition (botnet time, botnet C&C domain name, IP address, used bot binary, malicious behaviors, etc.) of statistics items. The sequence queries the search conditions selected by the user as the botnet information database and malicious behavior database to collect [5] information and display [6] the results on the screen.

As shown in FIG. 19, for a domain name system sink hole traffic statistics sequence, a user starts [1] botnet zombie statistics in a menu. Then, the sequence performs the query to the botnet information database by setting a basic search condition as “one recent week” to collect [2] the results. The sequence displays [3] the collected domain name system sink hole server traffic as transition graphs and tables on a screen. The user requests [4] the pertinent statistics by using the search condition (source IP) of statistics items. The sequence queries the search conditions selected by the user as the botnet information database and malicious behavior database to collect [5] information and display [6] the results on the screen.

As shown in FIG. 20, for an integrated report sequence, a user starts [1] an integrated report in a menu by selecting name, format, period, type, etc. of the integrated report and clicking a button of “Generation of report.” Then, the sequence queries the botnet information database and malicious behavior information database according to the search conditions selected by the user to collect [2] the results. The sequence generates the pertinent report and writes [3] the result in a report table and displays [4] the generated report on a screen.

As shown in FIG. 21, for a report reservation sequence, a user starts [1] a report reservation in a menu. The sequence queries a reservation report list database and reads [2] the list result to display [3] the list result on a screen. Then, if the user selects reservation registration, a reservation registration window is displayed on the screen. The user selects a type of report to be reserved on the reservation registration window and also selects name and extension of the report and period to click [6] a report reservation button. The sequence stores [7] pertinent report information in a reservation report list database and display [8] the reservation report list on the screen. If it is on the reservation time, the sequence performs the query to the botnet information database, the malicious behavior database, etc. to collect information and generates and stores [9] the pertinent report in the report database.

The botnet monitoring (BM) module provides a monitoring function that easily checks a botnet organization and a malicious behavior and a reporting function for the generated statistics data. For this, the botnet monitoring (BM) module can include a organization visualizing module monitoring the organization of a botnet, and a behavior visualizing module monitoring the malicious behavior of a botnet.

As shown in FIGS. 22 and 23, if a user starts [1] a system, the BM module requires [2] a C&C map window and a C&C list, which is all information related to the C&C. Moreover, the BM module queries [3] C&C information to the botnet information database and receives [4] and [5] information related to zombie and C&C in another ISP network (OtherISPList). At this time, the botnet information database recognizes C&C information (CCList) in the database and whether the information is in the present ISP network or another ISP network to transmit [6] the result information. Then, the BM module outputs [7] the C&C map and the C&C list, and the user clicks [8] a specific C&C in the map. The BM module also request [9] the PM module to visualize zombie map and zombie list of the pertinent C&C (CC) and representative attack types. At this time, the PM module requests [10] the botnet information database to provide zombie information of the pertinent C&C (CC). Accordingly, the botnet information database transmits [11] the zombie information to the PM module. Thereafter, the PM module requests [12] the malicious behavior database to provide the attack type of the pertinent zombies, and the malicious behavior database transmits [13] the attack type of the pertinent zombies. Accordingly, the PM module analyzes the zombie list and the attack type to find [14] the most used attack type (Highzom). Then, the PM module requests [15] the visualizing policy database to visualize the most used attack type (Highzom) and receives corresponding visual information (Attackvisual). Accordingly, the PM module visualizes and outputs [17] the zombie position, zombie list, and representative attack type.

As shown in FIG. 24, for a sequence of refresh, zoom in/zoom out, and timer, if a manager requests [1] the refresh, the PM module requests [2] a C&C map window and a C&C list, which is all information related to the C&C. The PM module queries [3] C&C information to the botnet information database and receives [4] and [5] information related to zombie and C&C in another ISP network (OtherISPList). At this time, the botnet information database recognizes C&C information (CCList) in the database and whether the information is in the present ISP network or another ISP network to transmit [6] the result information. Then, if the C&C map and C&C list is outputted [7] to a graphic user interface, a user requests [8] the zoom in/zoom out (InOut). The user requests [9] the PM module to provide a new botnet map and list according to the zoom in/zoom out (InOut). The PM module changes 10 the range of user's botnet map and list according to the zoom in/zoom out (InOut). The new botnet map and list is outputted to the graphic user interface. Then, the user designates and requests [12] a timer time and requests [13] the PM module to provide a botnet map and list corresponding to the timer time (Start-End). The PM module requests [14] the botnet information database to provide C&C information corresponding the pertinent time. The PM module requests and receives [15] and [16] information related to zombie and C&C in another ISP network (OtherISPList). The botnet information database recognizes C&C information (CCList) in the database and whether the information is in the present ISP network or another ISP network to transmit [17] the result information. Then, the botnet information database also outputs [18] the C&C map and list to the graphic user interface.

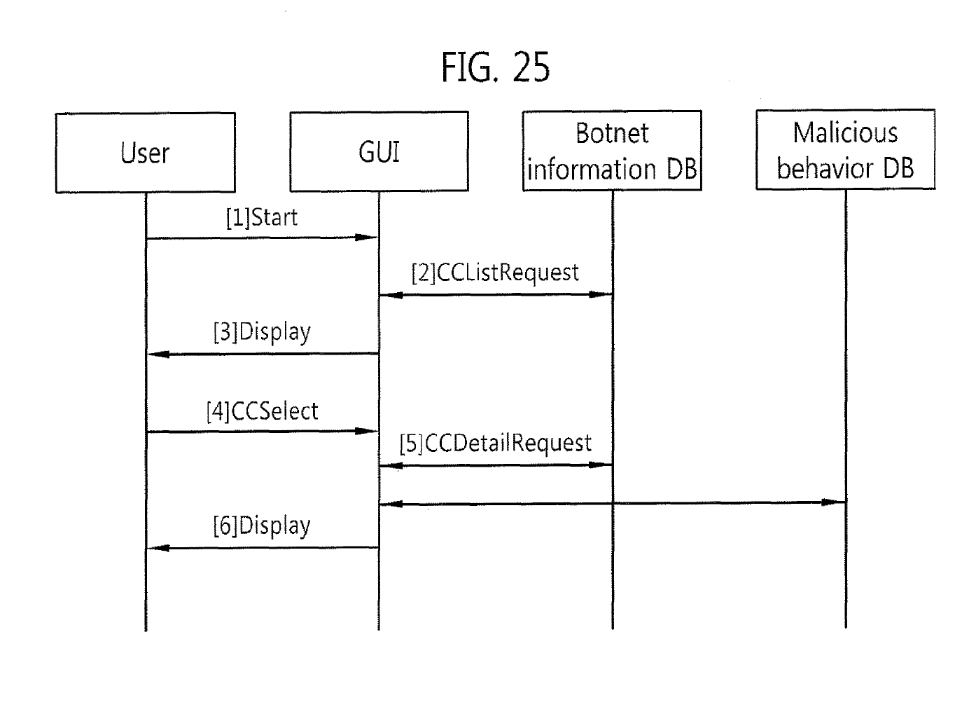

As shown in FIG. 25, for a TOP N statistics sequence of the SRM module, a user firstly starts [1] a TOP N statistics in a menu. Then, the sequence performs the query to the botnet information database by setting a basic search condition as “one recent week” to collect [2] the results. The sequence displays [3] the collected botnet statistics (botnet type, botnet C&C, botnet domain name, number of zombies, etc.) in a descending order on a screen. The user requests [4] the pertinent statistics by using the search condition of statistics items. The sequence queries the search conditions selected by the user as the botnet information database and malicious behavior database to collect [5] information and display [6] the results on the screen.

As shown in FIG. 26, the detection log management (DLM) module is a processor for managing botnet information, botnet malicious behavior information, system information, policy information, botnet against policy information, etc. The DLM module is also requested to insert/delete/correct/search logs to a equipment information database, a botnet against information database, a botnet information database, a malicious database, a policy database, etc. from the SM module, the BAT module, the SRM module, the BM module, and the PM module to return the result. As such, the DLM module includes a connection pool module managing the connection with the databases, a query classifying module, an enquiry/inserting/deleting/correcting module, a duplicate checking module, a SQLP generating/transmitting module, and a result transmitting module.

The connection pool module, which is a buffer managing the connection with the databases, generates a database connection in advance and performs the allotment when the database connection is requested.

The query classifying module classifies the requests to the DLM module and transfers the classified requests to the enquiry/inserting/deleting/correcting module. The enquiry/inserting/deleting/correcting module deals with the enquiry/inserting/deleting/correcting requests.

The duplicate checking module checks whether there is any duplicate of the inserting request to the database and the correcting request in the enquiry/inserting/deleting/correcting module. The SQLP generating/transmitting module receives request messages and generates corresponding SQL to transfer the SQL. The result transferring module returns the acknowledged result after the generated SQL is transferred.

The policy management (PM) module determines a policy related to modules that are being executed in the BMSM system. The PM module also determines a detection policy of the botnet detection system registered in the BMSM system and further determines a traffic information collecting sensor policy through the registered botnet detection system. For this, the PM module can include a policy generating module, and a policy transmitting module.

As shown in FIG. 27, the system management (SM) module registers the botnet detection system, the traffic information collecting sensor, the domain name system sink hole server, the BGP router, the domain name system server, the web firewall, etc. to the BMSM system. The SM module also provides on/off and function monitoring related to the registered botnet detection system and traffic information collecting sensor. As such, the SM module includes a web user interface, accessible and usable by a manager, and a system managing processor. The SM module performs the registration, correction, and deletion of system through a web user interface and performs the monitoring and environment setting of the registered traffic information collecting sensor and the botnet detecting system. The system managing system performs a state information processing of receiving state information (on/off, cpu usage) transferred from a plurality of traffic information collecting sensors and botnet detection systems and deals with a state information enquiry request from the consol graphic user interface.

For the state information processing, the traffic information collecting sensors and the botnet detection systems periodically transmit the state information to the BMSM system. At this time, the SM module receives information only transmitted from the registered traffic information collecting sensors and botnet detection systems. The received state information message undergoes state a message collecting/classifying operation and then is stored in a state information storing buffer.

For the dealing with a state information enquiry request from the consol graphic user interface, the management consol graphic user interface requests the state information of the registered traffic information collecting sensors and botnet detection systems according to the requests of the manager. The SM module receives the state information requesting massage and enquiries the state information stored in the state information storing buffer.

As described above, the present invention provides a security system of managing IRC and HTTP botnets that can efficiently performs the security management of IRC and HTTP botnets by using the BMSM system.

Next, a security method of managing IRC and HTTP botnets will be briefly described with reference to FIG. 28.

The duplicate description related to the security system of managing IRC and HTTP botnets in accordance with an embodiment of the present invention will be omitted or simplified. The detailed description of each process of the security method is substantially identical to that of the security system. Accordingly, the description thereof will be omitted.

FIG. 28 is a flowchart for describing a security method of managing IRC and HTTP botnets in accordance with an embodiment of the present invention.

As shown in FIG. 28, the security system manages IRC and HTTP botnets in accordance with an embodiment of the present invention includes processes of detecting a botnet S₁, establishing an against policy S₂, and creating a statistics data S₃.

In the process S₁ of detecting a botnet, botnets are detected in each of a plurality of Internet service provider networks. As such, the process S₁ includes first sub-processes of collecting traffic information S₁₋₁ and classifying logs S₁₋₂, and processing the logs S₁₋₃.

In the first sub-process S₁₋₁ of collecting traffics, traffic information is collected in each of a plurality of Internet service provider networks. Herein, the Internet service network providing network, which includes a traffic information collecting sensor, collects domain name system traffics, traffic information, etc. according to a traffic collecting policy in the BMSM system. At this time, the traffic collecting policy may be a traffic having, e.g., central-concentrative accessing characteristic that accesses a specific server concentratively.

In the first sub-process S₁₋₂ of establishing an against policy, security events of the collected traffics are classified. At this time, the classified security events include detection logs, classified behavior logs, abnormal organization logs, and non-classified behavior logs.

In the first sub-process S₁₋₃ of creating a statistics data, logs of the traffics collected in the process S₁₋₁ is analyzed. Such a process of analyzing the logs includes second sub-processes of dealing with the detection logs S₁₋₃₋₁, dealing with the classified organization logs S₁₋₃₋₂, dealing with the abnormal organization logs S₁₋₃₋₃, and dealing with the non-classified behavior logs S₁₋₃₋₄.

In the second sub-process S₁₋₃₋₁ of dealing with the detection logs, the detection logs classified from the security events are stored in the botnet information database. Thereafter, when the function of “automatic against policy setting” of the detection information is turned on, it is checked whether there is a botnet C&C access blocking against policy. At this time, if there is no botnet C&C access blocking against policy, a request message of creating the botnet C&C access blocking against policy is generated and transmitted to the BAT module.

In the second sub-process S₁₋₃₋₂ of dealing with the classified organization logs, the classification logs classified from the security events are stored in the botnet behavior database. Thereafter, when the function of “automatic against policy setting” of the detection information is turned on, it is checked whether there is a botnet malicious behavior against policy. At this time, if there is no botnet malicious behavior against policy, a request message of creating the botnet malicious behavior against policy is generated and transmitted to the BAT module.

In the second sub-process S₁₋₃₋₃ of dealing with the abnormal organization logs, the abnormal organization logs classified from the security events are stored in the abnormal organization log buffers. The AOA module periodically searches the abnormal organization log buffers. If the searched abnormal organization log buffer is not the present time entry, the pertinent abnormal organization log is deleted. The organization logs corresponding to the present time entry is stored based on C&C information. Thereafter, if an IP count value is greater than a threshold value, it is detected that there is a botnet. Based on the detected botnet information, a request message of “black list sharing” is generated and transmitted to the PM module.

In the second sub-process S₁₋₃₋₄ of dealing with the non-classified behavior logs, the non-classification logs classified from the security events are stored in the non-classification behavior log buffer.

In the process S₃ of creating an against policy, botnet information detected in a BMSM system in a different ISP network is received and an against policy is created based on the detected botnet information. The against policy may be embodied by the BAT module. At this time, the against policy may be related to sharing of the black lists determined as the botnet, domain name system sink hole application, BGP feeding, HTTP botnet C&C access URL blocking, etc.

In the process S₃ of creating a statistics data, the botnet information and the malicious behavior information is created as various graphs and statistics data. At this time, the generated statistics data may be reported and the creating and reporting of the statistics data may be embodied through a web-based user interface.

While the invention has been shown and described with respect to the embodiments, it will be understood by those skilled in the art that various changes and modification may be made without departing from the scope of the invention as defined in the following claims.

What is claimed is:

1. A system that detects a botnet in an Internet service provider network to store information related to the detected botnet in a database and performs security management of IRC and HTTP botnets, the system comprising
a botnet management security management (BMSM) system, configured to visualize the information related to the detected botnet and establish an against policy related to the detected botnet.

2. The system of claim 1, further comprising:
a plurality of traffic information collecting sensors, placed in a plurality of Internet network provider networks to transfer traffic information to the BMBS system; and
a managing system, configured to manage the traffic information collecting sensors and setting and state information of a botnet detection system.

3. The system of claim 1, wherein the BMSM system comprises:
a security event collector module, configured to receive a security event from the botnet detection system and deal with the received security event;
an anomaly organization log analysis log, configured to analyze a similarity with the botnet of the security event;
an unclassified behavior log analysis module, configured to receive and classify unclassified behavior logs in the security event;
a botnet against technology module, configured to establish the against policy related to the detected botnet;
a detection log management module, configured to manage the information related to the detected botnet, botnet malicious behavior information, policy information and botnet against policy information;
a policy management module, configured to set a policy of the BMSM system;
a system management module, configured to register the botnet detection system, the traffic information collecting sensor, a domain name system sink hole server, a BGP router, a domain name system server, and a web firewall to the BMSM system;
a statistic reporting management module, configured to create statistics data based on the information related to the detected botnet and the malicious behavior information; and
a botnet monitoring module, configured to monitor a malicious behavior and an organization of the detected botnet.

4. The system of claim 3, wherein the security event collector module comprises:
a security event collection classification module, configured to classify the collected security events;
an against policy checking module, configured to transmit an against policy request message for blocking botnets according to the policy established by the policy management module;
a collection/classification/policy generation management module for the security event; and
an abnormal organization log buffer, configured to store an abnormal organization log in the collected security event.

5. The system of claim 3, wherein the anomaly organization log analysis log comprises:
an abnormal organization log search/classification module, configured to periodically read an abnormal organization log buffer in the security event and write an organization log, which is generated in a same time slot, in a matrix per organization;
a botnet C&C comparison module, configured to compare botnet C&C information in a present time slot with botnet C&C information in a previous time slot;
a C&C analyzing and detecting module, configured to analyze a similarity with source IPs of botnet C&C of the present and previous time slot;
a C&C extracting module, configured to receive a botnet traffic detected from the C&C analyzing and detecting module and extracts C&C per protocol to store the analysis result in a log; and
an against policy setting module generates a requiring message for setting a black list generation against policy related to a newly detected botnet C&C in the BMSM system.

6. The system of claim 5, wherein the botnet against technology module sets a botnet against policy including black list sharing, domain name system sink hole, HTTP botnet C&C URL access blocking, and BGP feeding.

7. The system of claim 3, wherein the detection log management module comprises:
a connection pool module, configured to manage a connection with the database;
an enquiry/inserting/deleting/correcting module, configured to deal with requests of enquiry, inserting, deleting, and correcting for the database;
a query classifying module, configured to classify request messages to the detection log management module and transfer the classified request messages to the enquiry/inserting/deleting/correcting module;
a duplicate checking module, configured to check whether there is any duplicate of an inserting request to the database and a correcting request in the enquiry/inserting/deleting/correcting module;
a SQLP generating/transmitting module, configured to receive request messages and generate corresponding SQL to transfer the SQL; and
a result transmitting module, configured to returns the acknowledged result after the generated SQL is transferred.

8. The system of claim 3, wherein the system management module
receives and deals with state information transmitted from the plurality of traffic information collecting sensors that collect botnet information in the Internet service provider network or the botnet detection systems that detect the botnets based on the traffic collected by the traffic information collecting sensors and
deals with a state information enquiry request from a management consol graphic user interface through which a user is able to manipulate the BMSM system displayed on a web.

9. A method that detects a botnet in an Internet service provider network to store information related to the detected botnet in a database and performs security management of IRC and HTTP botnets, the method comprising:
detecting a botnet in the Internet service provider network; and
establishing an against policy of the botnet.

10. The method of claim 9, wherein the detecting of the botnet in the Internet service provider network comprises:
collecting a traffic in the Internet service provider network;
classifying logs based on the collected traffic; and
dealing with the logs.

11. The method of claim 10, wherein the logs include detection logs, classification behavior logs, abnormal organization logs, and non-classification behavior logs.

12. The method of claim 11, wherein the dealing with the logs comprises:
dealing with the detection logs;
dealing with the classification behavior logs;
dealing with the abnormal organization logs; and
dealing with non-classification behavior logs.

13. The method of claim 10, further comprising creating statistics data for the information related to the detected botnet.
